(19) United States
(12) Patent Application Publication
(10) Pub. No.: US 2025/0331621 A1
(43) Pub. Date: Oct. 30, 2025

(54) MILL TRANSMISSION DEVICE

(71) Applicant: ZHIBING WANG, Leiyang City (CN)

(72) Inventor: ZHIBING WANG, Leiyang City (CN)

(21) Appl. No.: 18/954,663

(22) Filed: Nov. 21, 2024

(30) Foreign Application Priority Data
Apr. 26, 2024 (CN) 2024209015177

(51) Int. Cl. A45D 29/14; B24B 5/02

(52) U.S. Cl. CPC A45D 29/14; B24B 5/02

(57) ABSTRACT

The present disclosure relates to the technical field of mills, and discloses a mill transmission device. In the mill transmission device, an output end of a motor is provided with a cross column that is the same as that at a top of a connecting shaft rod, and the cross column at the output end of the motor is inserted into a first connection port A, which drives a shaft tube to rotate. A rubber ring A embedded in the first connection port A is capable of reducing vibration and noise caused by rotation. Similarly, the shaft tube is detachably connected to the connecting shaft rod through a second connection port B and a rubber ring B, and the rubber ring B is also capable of reducing the noise and vibration caused by rotation of the shaft tube.

### CROSS REFERENCE TO RELATED APPLICATION

This application claims priority benefit of Chinese patent application CN 2024209015177, filed Apr. 26th 2024. The content of the aforementioned application, including any intervening amendments thereto, are incorporated herein by reference.

### TECHNICAL FIELD

The present disclosure relates to the technical field of mills, and particularly relates to a mill transmission device.

### BACKGROUND

People generally use nail polish pens to remove nail polish from their fingers. A nail polish pen includes a conical tip and a motor, where the motor drives the tip to rotate around its own axis, and a side surface of the tip rubs against a nail surface to polish it.

A transmission shaft in the prior art is a single shaft rod, and the shaft rod is detachably connected with a grinding head. However, some noise is generated during rotation of the shaft rod. Once the grinding head comes into contact with the nail surface, vibration and noise will increase, such that the transmission shaft shakes, which indirectly damages the nail surface.

### SUMMARY

### (1) Technical Problems

In order to overcome the defects of the prior art, the present disclosure provides a mill transmission device with the advantages of reducing vibration and noise, and solves the above problems

### (2) Technical Solution

To achieve the above objective of reducing vibration and noise, the present disclosure provides the following technical solution: a mill transmission device, including a shaft tube, a connecting shaft rod, a spring, a bearing assembly, and a tubular chuck, where the shaft tube is sleeved at one end of the connecting shaft rod, the spring is sleeved on an outer side of the connecting shaft rod, the tubular chuck is inserted into the bearing assembly, one end of the tubular chuck is fixedly connected to the other end of the connecting shaft rod, and the other end of the tubular chuck extends from the bearing assembly outward.

A top end of the shaft tube is provided with a first connection port A, a bottom end of the shaft tube is provided with a second connection port B, a shaft hole is formed between the first connection port A and the second connection port B, an inner wall of the first connection port A is provided with a rubber ring A in an embedded manner, and an inner wall of the second connection port B is provided with a rubber ring B in an embedded manner.

The bearing assembly includes a housing, a top end of the housing is threadedly connected with a housing cover, a shaft rod sleeve is installed between the housing and the housing cover in an inserted manner, an outer side of the shaft rod sleeve is sleeved with a roller A and a roller B respectively, the outer side of the shaft rod sleeve is further sleeved with a limiting sleeve, a push ring is fixedly mounted on the shaft rod sleeve and on a side of the roller B, one end of the push ring is located inside the housing, and the other end of the push ring penetrates through the housing and extends from the housing outward.

Preferably, a limiting plate is fixedly mounted on the outer side of the connecting shaft rod, the spring is located below the limiting plate, an outer surface of a bottom end of the connecting shaft rod is provided with an external threaded groove, a cross column is fixedly mounted at a top of the connecting shaft rod, a convex ring is fixedly mounted on an outer surface of the cross column, and the cross column penetrates into the second connection port B and extends into inside of the shaft hole.

The tubular chuck includes a snap-fit tube, a boss tube is formed at a front end of the snap-fit tube, a plurality of crack grooves are formed in the snap-fit tube in a length direction, the plurality of crack grooves extend to the boss tube and penetrate through the boss tube, and the snap-fit tube is configured for installing a grinding rod.

Preferably, the shaft rod sleeve is a tubular structure with both ends through with each other, the tubular chuck penetrates through the shaft rod sleeve and is slidably connected inside the shaft rod sleeve from front to back, and one end of the tubular chuck is butt-jointed with the connecting shaft rod.

Preferably, the shaft rod sleeve is sleeved on an outer side of the snap-fit tube, a top end of the shaft rod sleeve abuts against a bottom end of the spring, and a bottom end of the shaft rod sleeve penetrates through and extends to an outer side of the housing.

Preferably, outer rings of the roller A and the roller B are fixedly connected to the housing, inner rings of the roller A and the roller B are fixedly connected to an outer surface of the shaft rod sleeve, and the outer rings of the roller A and the roller B are fixedly connected through the limiting sleeve.

Preferably, a top end of the shaft tube is detachably snap-fitted with an output end of a motor through the first connection port A and the rubber ring A.

Preferably, a bottom end of the shaft tube is detachably snap-fitted with a cross column at a top of the connecting shaft rod through the second connection port B and the rubber ring B.

Preferably, a conical surface is arranged at a bottom opening of the shaft rod sleeve, and the conical surface is fitted with the boss tube, such tube is compressed and locked.

Preferably, the bearing assembly further includes at least two O-shaped rubber rings embedded in the housing and the housing cover.

### (3) Beneficial Effects

Compared with the prior art, the present disclosure provides a mill transmission device, and has the following beneficial effects:
1. To sum up, in the mill transmission device, an output end of a motor is provided with a cross column that is the same as that at a top of a connecting shaft rod, and the cross column at the output end of the motor is inserted into a first connection port A, which drives a shaft tube to rotate. A rubber ring A embedded in the first connection port A is capable of reducing vibration and noise caused by rotation. Similarly, the shaft tube is detachably connected to the connecting shaft rod through a second connection port B and a rubber ring B, and the rubber ring B is also capable of reducing the noise and vibration caused by rotation of the shaft tube.
2. In the mill transmission device, the shaft rod sleeve, through the roller A and the roller B, rotates relative to the housing, and the roller A and the roller B are connected through the limiting sleeve, which enhances the stability of the roller A and the roller B, and indirectly ensures the stability of the shaft rod sleeve during rotation.

### BRIEF DESCRIPTION OF THE DRAWINGS

FIG. 1 is a schematic diagram of a three-dimensional structure of the present disclosure.

FIG. 2 is a schematic diagram of a three-dimensional breakdown structure of the present disclosure.

FIG. 3 is a schematic diagram of a three-dimensional structure of a connecting shaft rod and a tubular chuck of the present disclosure.

FIG. 4 is a schematic diagram of a planar structure of the present disclosure.

FIG. 5 is a schematic diagram of a sectional structure of the present disclosure in an A-A direction in FIG. 4.

FIG. 6 is a structural schematic diagram of a shaft tube of the present disclosure.

FIG. 7 is a schematic state diagram of a tubular chuck installed with a grinding rod in the present disclosure.

### DETAILED DESCRIPTIONS OF THE EMBODIMENTS

The technical solutions in the examples of the present disclosure will be clearly and completely described below with reference to the accompanying drawings in the examples of the present disclosure. Obviously, the described examples are merely some examples rather than all examples of the present disclosure. Based on the embodiments of the present disclosure, all other embodiments obtained by those of ordinary skill in the art without making creative efforts shall fall within the protection scope of the present disclosure.

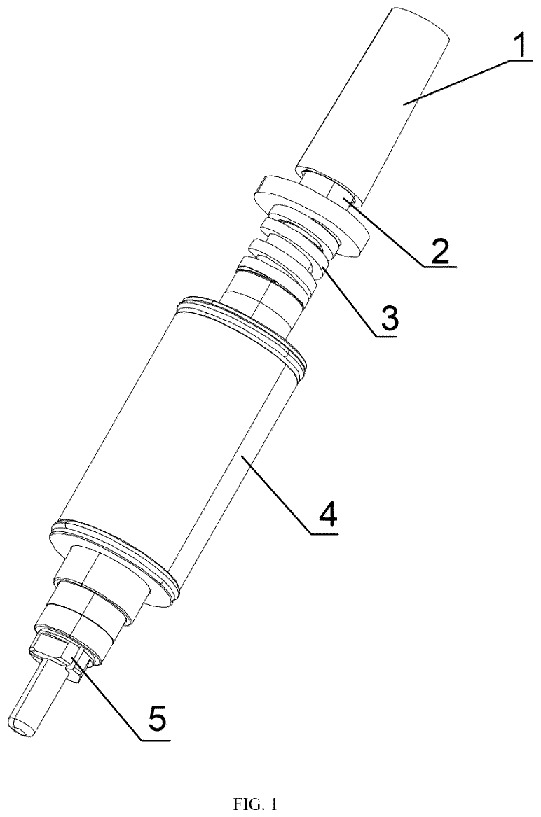

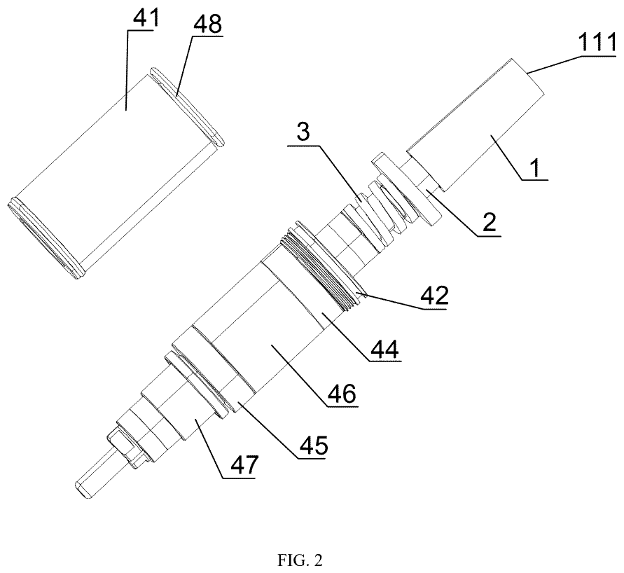

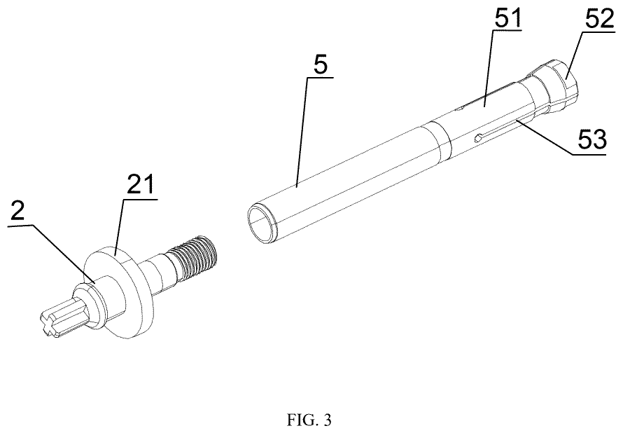

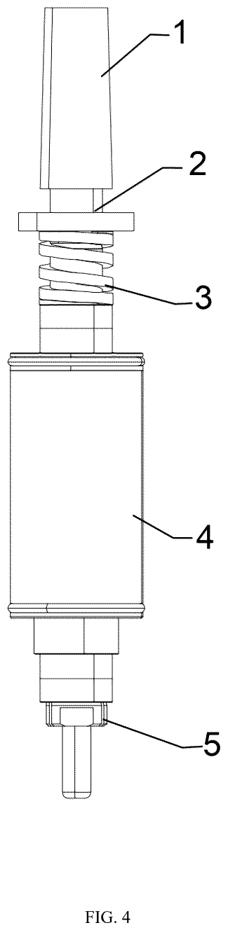

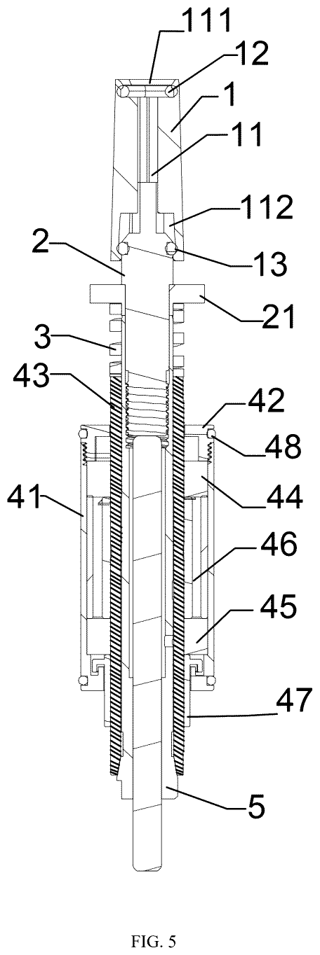

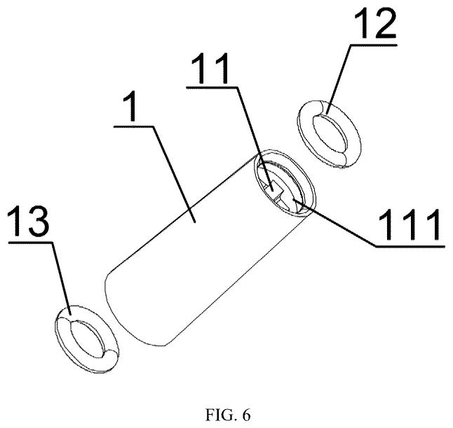

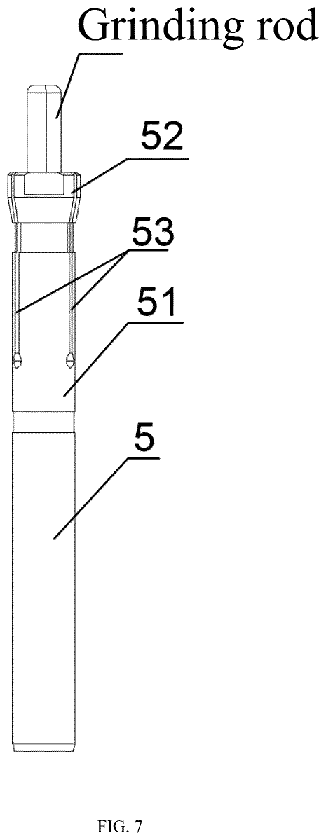

With reference to FIGS. 1-7, a mill transmission device includes a shaft tube 1, a connecting shaft rod 2, a spring 3, a bearing assembly 4, and a tubular chuck 5, where the shaft tube 1 is sleeved at one end of the connecting shaft rod 2, the spring 3 is sleeved on an outer side of the connecting shaft rod 2, the tubular chuck 5 is inserted into the bearing assembly 4, one end of the tubular chuck 5 is fixedly connected to the other end of the connecting shaft rod 2, and the other end of the tubular chuck 5 extends from the bearing assembly 4 outward.

With reference to FIGS. 1-7, a top end of the shaft tube 1 is provided with a first connection port A111, and a bottom end of the shaft tube 1 is provided with a second connection port B112. A shaft hole 11 is formed between the first connection port A111 and the second connection port B112. An inner wall of the first connection port A111 is provided with a rubber ring A12 in an embedded manner, and a top end of the shaft tube 1 is detachably snap-fitted with an output end of a motor through the first connection port A111 and the rubber ring A12, where the rubber ring A12 is capable of reducing noise and vibration. An inner wall of the second connection port B112 is provided with a rubber ring B13 in an embedded manner. A bottom end of the shaft tube 1 is detachably snap-fitted with a cross column at a top of the connecting shaft rod 2 through the second connection port B112 and the rubber ring B13, where the rubber ring B13 is capable of reducing noise and vibration caused by rotation of the shaft tube 1.

With reference to FIGS. 1-7, the bearing assembly 4 includes a housing 41, and a top end of the housing 41 is threadedly connected with a housing cover 42. A shaft rod sleeve 43 is installed between the housing 41 and the housing cover 42 in an inserted manner, a top end of the shaft rod sleeve 43 abuts against a bottom end of the spring 3, and a bottom end of the shaft rod sleeve 43 penetrates through and extends to an outer side of the housing 41.

With reference to FIGS. 1-7, an outer side of the shaft rod sleeve 43 is sleeved with a roller A44 and a roller B45 respectively, where outer rings of the roller A44 and the roller B45 are fixedly connected to the housing 41, and inner rings of the roller A44 and the roller B45 are fixedly connected to an outer surface of the shaft rod sleeve 43. The outer side of the shaft rod sleeve 43 is further sleeved with a limiting sleeve 46, and the outer rings of the roller A44 and the roller B45 are fixedly connected through the limiting sleeve 46, to improve stability of the shaft rod sleeve 43 during rotation. A push ring 47 is fixedly mounted on the shaft rod sleeve 43 and on a side of the roller B45, one end of the push ring 47 is located inside the housing 41, and the other end of the push ring 47 penetrates through the housing 41 and extends from the housing 41 outward. The push ring 47 is in contact with and abuts against the inner ring of the roller B45, and when the push ring 47 is pushed upward, the entire shaft rod sleeve 43 moves upward, and the spring 3 is compressed, such that the tubular chuck 5 is exposed.

With reference to FIGS. 1-7, a limiting plate 21 is fixedly mounted on the outer side of the connecting shaft rod 2, the spring 3 is located below the limiting plate 21, and an outer surface of a bottom end of the connecting shaft rod 2 is provided with an external threaded groove. A cross column is fixedly mounted at a top of the connecting shaft rod 2, a convex ring is fixedly mounted on an outer surface of the cross column, and the cross column penetrates into the second connection port B112 and extends into inside of the shaft hole 11.

With reference to FIGS. 1-7, the shaft rod sleeve 43 is a tubular structure with both ends through with each other, the tubular chuck 5 penetrates through the shaft rod sleeve 43 and is slidably connected inside the shaft rod sleeve 43 from front to back, and one end of the tubular chuck 5 is butt-jointed with the connecting shaft rod 2. The tubular chuck 5 includes a snap-fit tube 51, the shaft rod sleeve 43 is sleeved on an outer side of the snap-fit tube 51, an inner wall of a top end of the snap-fit tube 51 is provided with an internal threaded groove, and the snap-fit tube 51 is threadedly connected to the connecting shaft rod 2 through the external threaded groove and the internal threaded groove.

With reference to FIGS. 1-7, a boss tube 52 is formed at a front end of the snap-fit tube 51, a plurality of crack grooves 53 are formed in the snap-fit tube 51 in a length direction, and the plurality of crack grooves 53 extend to the boss tube 52 and penetrate through the boss tube 52. The snap-fit tube 51 is configured for installing a grinding rod, and a conical surface is arranged at a bottom opening of the shaft rod sleeve 43, where the conical surface is fitted with the boss tube 52, such that the boss tube 52 is compressed, gaps of the plurality of crack grooves 53 are narrowed, and the grinding rod installed inside the snap-fit tube 51 is compressed.

With reference to FIGS. 1-7, the bearing assembly 4 further includes at least two O-shaped rubber rings 48 embedded in the housing 41 and the housing cover 42, the housing 41 and the housing cover 42 are both provided with at least one annular mounting groove, and the two O-shaped rubber rings 48 are installed in the annular mounting grooves in one-to-one correspondence.

Working principle: in use, an upward force is applied to push the push ring 47 to move upward, such that the shaft rod sleeve 43 is driven to move upward too, the spring 3 is passively compressed, the conical surface of the shaft rod sleeve 43 disengages from the boss tube 52, and the gaps of the plurality of crack grooves 53 are reset to an initial state, and in this case, the grinding rod in the snap-fit tube 51 can be removed. Conversely, after a new grinding rod is inserted into the snap-fit tube 51, when a force applied to the push ring 47 is released, the spring 3 pushes the shaft rod sleeve 43 to move downward, the conical surface of the shaft rod sleeve 43 presses against the boss tube 52, the gaps of the crack grooves 53 are narrowed, and then the grinding rod is compressed tightly.

To sum up, in the mill transmission device, the output end of the motor is provided with a cross column that is the same as that at the top of the connecting shaft rod 2, and the cross column at the output end of the motor is inserted into the first connection port A111, which drives the shaft tube 1 to rotate. The rubber ring A12 embedded in the first connection port A111 is capable of reducing the vibration and noise caused by rotation. Similarly, the shaft tube 1 is detachably connected to the connecting shaft rod 2 through the second connection port B112 and the rubber ring B13, and the rubber ring B13 is also capable of reducing the noise and vibration caused by rotation of the shaft tube 1.

In the mill transmission device, the shaft rod sleeve 43, through the roller A44 and the roller B45, rotates relative to the housing 41, and the roller A44 and the roller B45 are connected through the limiting sleeve 46, which enhances the stability of the roller A44 and the roller B45, and indirectly ensures the stability of the shaft rod sleeve 43 during rotation.

Although the examples of the present disclosure have been illustrated and described, it should be understood that those of ordinary skill in the art may make various changes, modifications, replacements and variations to the above examples without departing from the principle and spirit of the present disclosure, and the scope of the present disclosure is limited by the appended claims and their legal equivalents.

What is claimed is:

1. A mill transmission device, comprising a shaft tube, a connecting shaft rod, a spring, a bearing assembly, and a tubular chuck, wherein the shaft tube is sleeved at one end of the connecting shaft rod, the spring is sleeved on an outer side of the connecting shaft rod, the tubular chuck is inserted into the bearing assembly, one end of the tubular chuck is fixedly connected to the other end of the connecting shaft rod, and the other end of the tubular chuck extends from the bearing assembly outward; a top end of the shaft tube is provided with a first connection port (A), a bottom end of the shaft tube is provided with a second connection port (B), a shaft hole is formed between the first connection port (A) and the second connection port (B), an inner wall of the first connection port (A) is provided with a rubber ring (A) in an embedded manner, and an inner wall of the second connection port (B) is provided with a rubber ring (B) in an embedded manner; and
the bearing assembly comprises a housing, a top end of the housing is threadedly connected with a housing cover, a shaft rod sleeve is installed between the housing and the housing cover in an inserted manner, an outer side of the shaft rod sleeve is sleeved with a roller (A) and a roller (B) respectively, the outer side of the shaft rod sleeve is further sleeved with a limiting sleeve, a push ring is fixedly mounted on the shaft rod sleeve and on a side of the roller (B), one end of the push ring is located inside the housing, and the other end of the push ring penetrates through the housing and extends from the housing outward.

2. The mill transmission device according to claim 1, wherein a limiting plate is fixedly mounted on the outer side of the connecting shaft rod, the spring is located below the limiting plate, an outer surface of a bottom end of the connecting shaft rod is provided with an external threaded groove, a cross column is fixedly mounted at a top of the connecting shaft rod, a convex ring is fixedly mounted on an outer surface of the cross column, and the cross column penetrates into the second connection port (B) and extends into inside of the shaft hole.

3. The mill transmission device according to claim 2, wherein the tubular chuck comprises a snap-fit tube, a boss tube is formed at a front end of the snap-fit tube, a plurality of crack grooves are formed in the snap-fit tube in a length direction, the plurality of crack grooves extend to the boss tube and penetrate through the boss tube, and the snap-fit tube is configured for installing a grinding rod.

4. The mill transmission device according to claim 1, wherein the shaft rod sleeve is a tubular structure with both ends through with each other, the tubular chuck penetrates through the shaft rod sleeve and is slidably connected inside the shaft rod sleeve from front to back, and one end of the tubular chuck is butt-jointed with the connecting shaft rod.

5. The mill transmission device according to claim 1, wherein the shaft rod sleeve is sleeved on an outer side of the snap-fit tube, a top end of the shaft rod sleeve abuts against a bottom end of the spring, and a bottom end of the shaft rod sleeve penetrates through and extends to an outer side of the housing.

6. The mill transmission device according to claim 1, wherein outer rings of the roller (A) and the roller (B) are fixedly connected to the housing, inner rings of the roller (A) and the roller (B) are fixedly connected to an outer surface of the shaft rod sleeve, and the outer rings of the roller (A) and the roller (B) are fixedly connected through the limiting sleeve.

7. The mill transmission device according to claim 1, wherein a top end of the shaft tube is detachably snap-fitted with an output end of a motor through the first connection port (A) and the rubber ring (A).

8. The mill transmission device according to claim 2, wherein a bottom end of the shaft tube is detachably snap-fitted with a cross column at a top of the connecting shaft rod through the second connection port (B) and the rubber ring (B).

9. The mill transmission device according to claim 3, wherein a conical surface is arranged at a bottom opening of the shaft rod sleeve, and the conical surface is fitted with the boss tube, such that the boss tube is compressed and locked.

10. The mill transmission device according to claim 1, wherein the bearing assembly further comprises at least two O-shaped rubber rings embedded in the housing and the housing cover.
